(19) United States
(12) Patent Application Publication
(10) Pub. No.: US 2019/0070916 A1
(43) Pub. Date: Mar. 7, 2019

(54) TRAILER WITH SWIVEL CASTERS

(71) Applicant: Carrier Systems, LLC, Lebanon, IN (US)

(72) Inventors: James S. Nirider, Lebanon, IN (US); John A. Nirider, Brownsburg, IN (US)

(21) Appl. No.: 16/058,768

(22) Filed: Aug. 8, 2018

Related U.S. Application Data
(60) Provisional application No. 62/542,603, filed on Aug. 8, 2017.

(51) Int. Cl. B60D 1/24; B60B 33/00; B60D 1/14; B60D 1/30

(52) U.S. Cl. CPC B60D 1/245; B60B 33/0005; B60D 1/30; B60B 33/006; B60D 1/14; B60B 33/0042

(57) ABSTRACT

A trailer for a motor vehicle includes a bed, a trailer tongue, a tongue frame, and a plurality of swivel frames. The bed has a front end and a rear end, and is configured to receive a load to be transported by the trailer. The trailer tongue is configured to be rigidly coupled to a hitch, wherein the hitch is rigidly affixed to a motor vehicle. The tongue frame operable couples the trailer tongue to the bed proximate the front end in a laterally rigid manner, such that the bed is substantially inhibited from lateral movement with respect to the hitch. Each of the plurality of swivel frames is operably rotatably coupled to the bed, and includes at least one wheel rotatably attached thereto.

This application claims the benefit of U.S. Provisional Patent Application Ser. No. 62/542,603, filed Aug. 8, 2017, the entirety of which is incorporated herein by reference.

### FIELD OF THE INVENTION

The present invention relates generally to trailers, and more specifically, trailers that connect to motor vehicles.

### BACKGROUND

Trailer towed by motor vehicles have many uses and applications. For example, trailers may be used to haul other vehicles, such as motorcycles and boats, and/or work equipment such as lawn mowers, painting equipment, and the like. One of the challenges relating to the use of trailers is the difficult maneuvering the motor vehicle and tandem trailer in reverse. For example, U.S. Pat. No. 8,511,702 explains the difficulties in backing up a vehicle with a trailer. In particular, the trailer does not always follow the reverse path intended by the person steering the motor vehicle.

The prior art has attempted to address this difficulty with the use of caster-type wheels on the trailer. U.S. Pat. No. 4,305,602 shows a design that includes two spaced-apart attachment members that attach to two different hitches of the vehicle. This provides for uniform alignment of the trailer and the rear-end of the vehicle, thus preventing jack-knifing. However, one drawback of this design is that it requires two carefully spaced hitches on a vehicle, and thus a custom and expensive arrangement.

U.S. Pat. No. 8,511,702 discloses an anti-jackknifing system that employs a single point of attachment to the towing vehicle. The system employs caster-type wheels and a wheel locking mechanism that allows for the wheels to be locked in non-rotatable operation during normal forward travel of the vehicle. The wheel locking mechanism unlocks the wheels, and allows them to swivel, in reverse travel of the vehicle. The system also includes a slide plate locking mechanism that prevents lateral movement of the trailer with respect to the vehicle in one position, such as when the vehicle is in reverse with the caster wheels freely rotating, and allows lateral movement of the trailer in the other position, such as when the vehicle is traveling forward and the caster wheels are locked. Such a system, however, is complex and requires multiple modes of operation. Various moving parts can often require greater maintenance and greater opportunities for malfunction.

What is needed is a cost-effective system for a trailer to avoid jackknifing that addresses the shortcomings of the prior art.

### SUMMARY

At least some embodiments of the invention address the above-stated needs, as well as others, by providing a trailer having swivel casters, a laterally rigid connection to a vehicle via a trailer tongue and tongue frame, wherein the tongue frame coupled to the bed of the trailer in a laterally rigid manner.

A first embodiment is a trailer for a motor vehicle that includes a bed, a trailer tongue, a tongue frame, and a plurality of swivel frames. The bed has a front end and a rear end, and is configured to receive a load to be transported by the trailer. The trailer tongue is configured to be rigidly coupled to a hitch, wherein the hitch is rigidly affixed to a motor vehicle. The tongue frame operable couples the trailer tongue to the bed proximate the front end in a laterally rigid manner, such that the bed is substantially inhibited from lateral movement with respect to the hitch. Each of the plurality of swivel frames is operably rotatably coupled to the bed, and includes at least one wheel rotatably attached thereto.

A second embodiment is a trailer for a motor vehicle having a bed, a coupler, a coupling frame and a plurality of swivel frames. The bed has a front end and a rear end, and is configured to receive a load to be transported by the trailer. The coupler is configured to be coupled to a hitch of a motor vehicle. The coupling frame operably connects the coupler to the bed proximate the front end. The plurality of swivel frames is operably rotatably coupled to the bed. Each of the plurality of swivel frames includes two wheels rotatably attached thereto, wherein each of the two wheels has a different axis of rotation.

The above discussed features and advantages, as well as others, will become more readily apparent to those of ordinary skill in the art by reference the following detailed description and accompanying drawings.

### BRIEF DESCRIPTION OF THE DRAWINGS

FIG. 1A shows a perspective view of a first embodiment of a trailer for a motor vehicle according to the invention;

FIG. 1B shows a partially exploded perspective view of the trailer of FIG. 1A;

FIG. 2 shows a fragmentary, perspective view of the trailer tongue and tongue frame of the trailer of FIG. 1A, in combination with an exemplary hitch of a motor vehicle configured to receive the trailer tongue;

FIG. 3 shows in further detail a perspective view of a pin for use in the tongue frame of FIG. 2;

FIG. 4A shows a perspective view of the first mount of the trailer of FIG. 1A;

FIG. 4B shows a side plan view of the first mount of the trailer of FIG. 1A;

FIG. 5 shows a perspective view of an exemplary embodiment of a swivel caster and swivel mount plate of the trailer of FIG. 1A;

FIG. 6 shows a perspective view of the swivel frame of the swivel caster of FIG. 5; and

FIG. 7 shows an exploded perspective view of the swivel frame of FIG. 6;

FIG. 8 shows a perspective view of a second embodiment of a trailer for a motor vehicle according to the invention.

### DETAILED DESCRIPTION

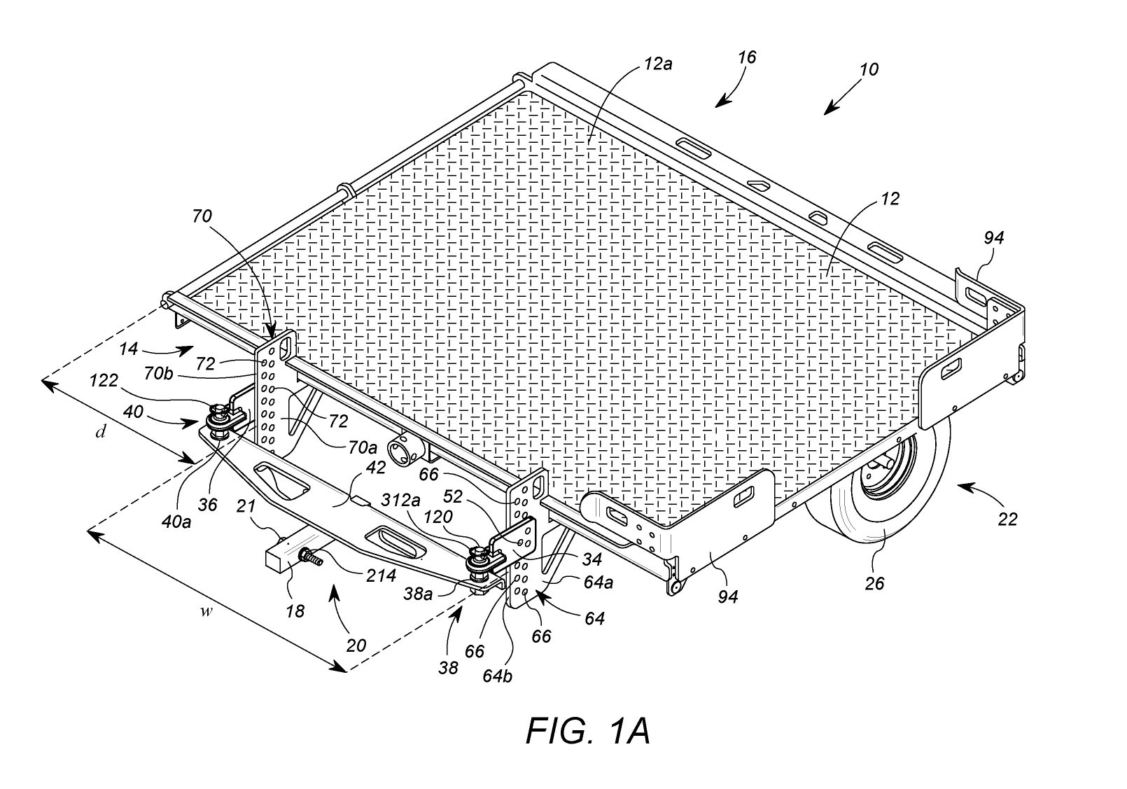

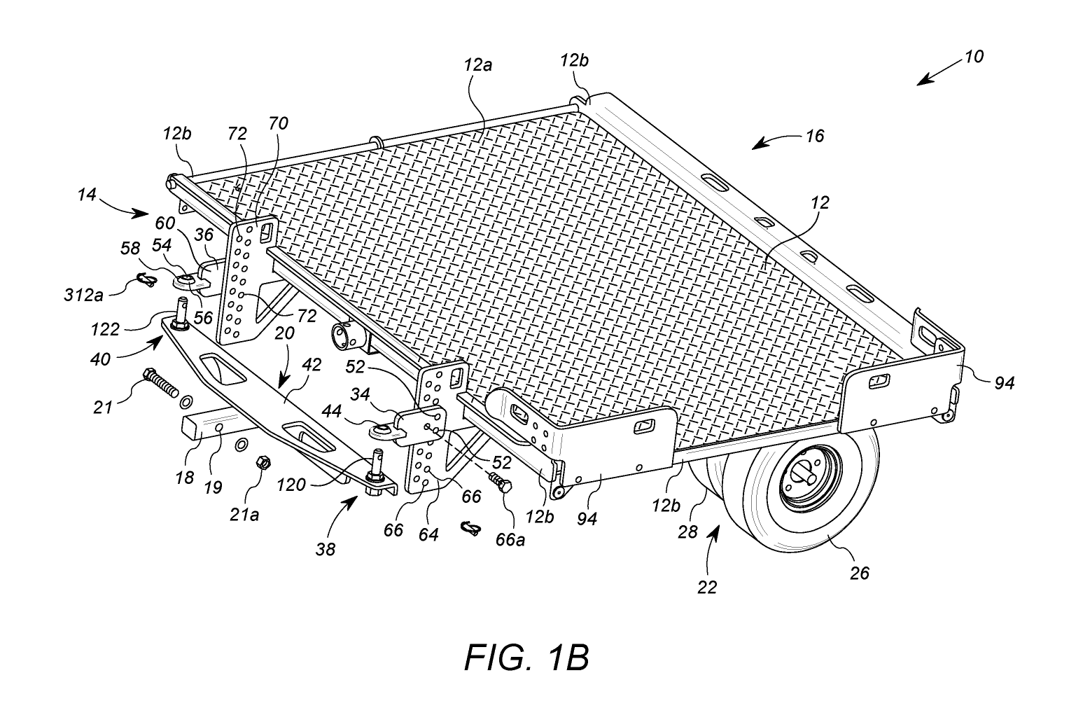

FIG. 1A shows a perspective view of a trailer 10 for a motor vehicle, not shown, and FIG. 1B shows a partially exploded view of the trailer 10. With simultaneous reference to FIGS. 1A and 1B, the trailer includes a bed 12, a trailer tongue or coupler 18, a trailer tongue frame or coupling frame 20, and first and second swivel casters, of which only a portion of swivel caster 22 is shown in FIGS. 1A and 1B. The swivel caster 22 preferably includes two wheels 26, 28, and the second swivel caster likewise includes two wheels, not shown. It is possible in some embodiments to use swivel casters having one wheel each. Each of the wheels 26, 28 has a suitably sized tire disposed on a rim in a conventional manner. The bed 12 has a front end 14 and a rear end 16. The front end 14 as discussed herein refers to the side or end that is closer to the vehicle when the trailer 10 is properly hitched, and the rear end 16 refers to opposite side or end.

The bed 12 is any structural frame and/or surface that supports a payload, or in other words, the item or items to be transported on the trailer 10, not shown. The bed 12 has a width that is generally within known trailer width standards, and comparable to that of an ordinary passenger vehicle, such as a pick-up truck. The bed 12 may have any suitable length, but in this embodiment has a length that is roughly equivalent to its width.

In this embodiment, the bed 12 is primarily formed of a steel plate 12a, with various structures attached thereto, including a support frame 12b, particularly around the edges thereof. For example, the bed 12 also includes L-shaped retaining side plates 94 disposed about portions of the edge of the bed plate 12a and extending upward from the bed frame 12b and upper surface of the bed plate 12a. The plates 94 cooperate with other structures attached to the bed plate 12a, discussed further below, to retain the payload on the bed 12. The portions of the edge of the bed 12 at which the plates 94 are placed will vary based on the design of the bed 12 and other structures. In this embodiment, the plates 94 are disposed around a first corner between the front end 14 and a first side of the bed 12, and around another corner between the rear end 16 and that same first side of the bed 12. The plates 94 may suitably be constructed of steel, and can be welded or bolted to the bed 12.

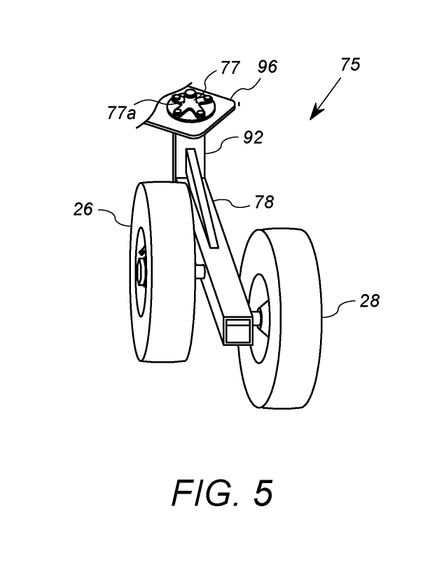

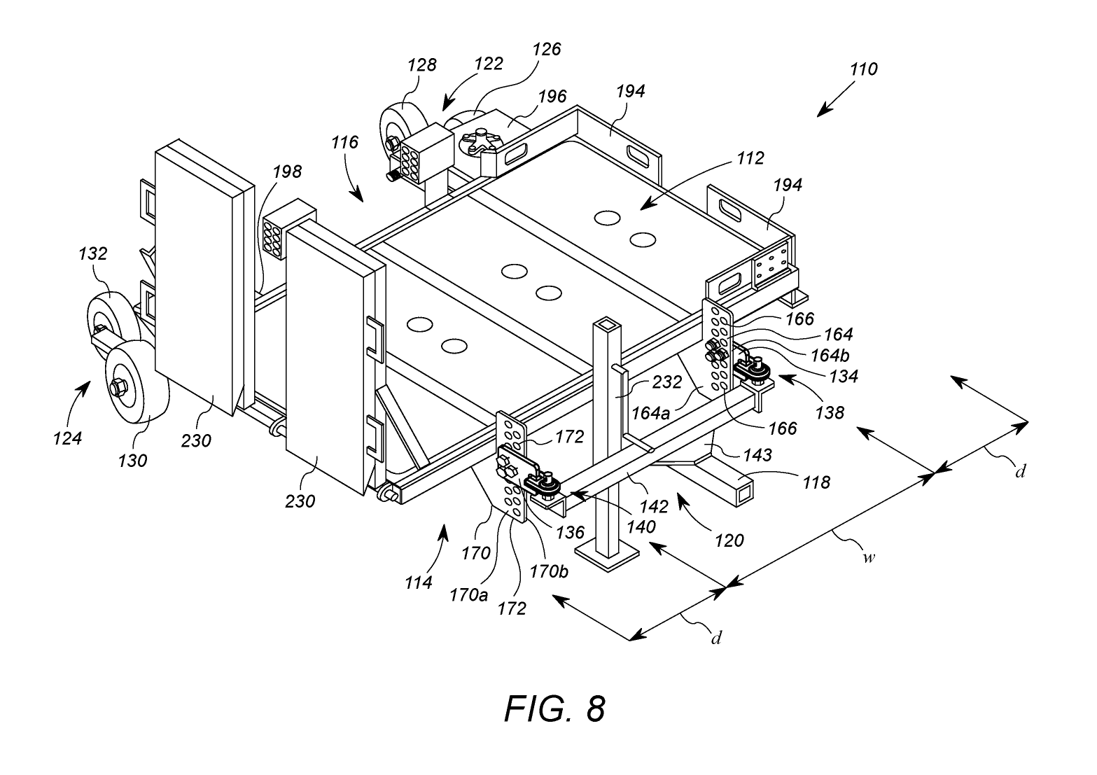

The bed frame 12b also includes first and second swivel mount plates coupled thereto. The swivel mount plates are not shown in FIGS. 1A and 1B because they are located under the steel plate 12a. However, the swivel plates are disposed on opposite sides of the rear end 16, and form a mounting structure for the swivel caster 22 and the corresponding second swivel caster, discussed further below in connection with FIGS. 5, 6 and 7. The swivel plates 196, 198 of the embodiment of FIG. 8 may suitably be used as the swivel mounting plates of the bed 12 of FIGS. 1A and 1B.

Also attached to the bed 12 are first and second mounting plates 64, 70. The first and second mounting plates 64, 70 are spaced apart on the front end 14 of the bed 12 and are generally symmetrically disposed with respect to the width of the bed 12. In this embodiment, the first and second plates 64, 70 are separated by a distance w on the front end 14 that exceeds the distance d between either plate 64, 70 and its respective closest side of the bed 12. The mounting plate 64 has a plurality of through-holes 66 disposed at different heights with respect to the bed 12. The mounting plate 70 similarly comprises a plurality of through-holes 72 at different heights with respect to the bed 12. In this embodiment, each of the mounting plates 64, 70 defines opposing planar surfaces (e.g. respective surfaces 64a, 70a) and a peripheral edge 64b, 70b. The mounting plates 64, 70 are attached to the bed 12 such that each of the planar surfaces (e.g. surfaces 64a, 70a and the respective opposing surfaces, not visible in FIGS. 1A and 1B) extend vertically and in the front-to-rear direction.

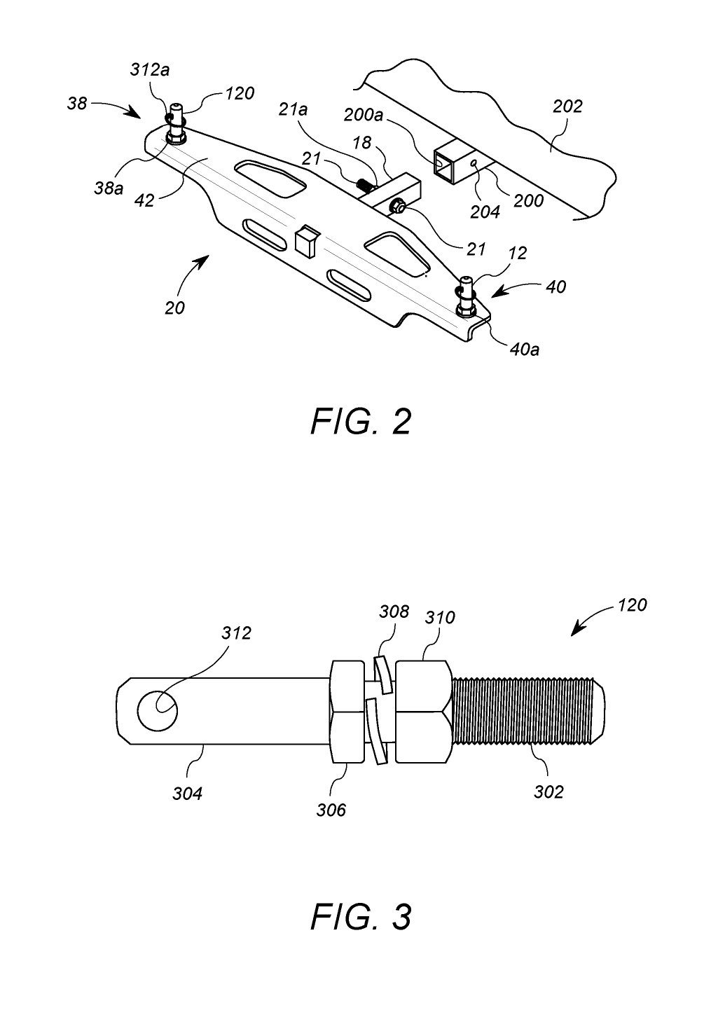

The trailer tongue 18 is configured to be rigidly coupled to a hitch that is rigidly affixed to a motor vehicle, not shown in FIG. 1. The tongue frame 20 operably couples the trailer tongue 18 to the bed 12 proximate the front end 14 in a laterally rigid manner, such that the bed 12 is substantially inhibited from lateral movement with respect to the hitch and rear end of the vehicle. FIG. 2 shows a fragmentary, perspective view of the trailer tongue 18, tongue frame 20, and an exemplary hitch 200 of a motor vehicle 202 configured to receive the trailer tongue 18. It will be appreciated that by “laterally rigid”, it is meant that the bed 12 does not articulate with respect to the vehicle 202. However, small lateral movements are nevertheless possible to accommodate uneven road surfaces. Laterally rigid therefore means substantially non-articulating, and need not imply or require absolute rigidity.

As shown in FIG. 2, the hitch 200 comprises a tube or steel with a generally rectangular cross-section, forming an interior 200a having a generally rectangular cross-section. Such hitches are well-known in the art. The hitch 200 preferably includes openings (e.g. opening 204 configured to receive a bolt having ⅝″ diameter, and which align with similar openings 19 on the tongue 18. The tongue 18 is a rigid, preferably steel, bar that is sized and configured to be received by and rigidly secured to the hitch 200. In this example, the tongue 18 may be a length of steel bar having a rectangular cross-section that complements, and is slightly smaller than, the cross-sectional shape of the interior 200a of the hitch 200. The tongue and sleeve design of the tongue 18 and the hitch 200 substantially prevents lateral and vertical movement of the tongue 18 and tongue frame 20 with respect to the hitch 200 and the rear end of the vehicle 202. A ⅝″ diameter bolt 21 (and corresponding nut 21a) extend through the sets of aligned openings 19, 204 to secure the tongue 18 to the hitch 200.

The tongue frame 20 operably couples the trailer tongue 18 to the bed 12 proximate the front end 14 in a laterally rigid manner, such that the bed is substantially inhibited from lateral movement with respect to the hitch. Referring to FIGS. 1 and 2, the tongue frame 20 in this embodiment tongue frame 20 includes a cross member 42 which may be a steel bar or plate and first and second spaced apart receivers 38, 40. The trailer tongue 18 is rigidly attached to middle of the crossbar 42. In this embodiment, the trailer tongue 18 is welded to the cross member 42. The cross member 42 in this embodiment includes a top horizontal plate 42a, and a vertical plate 42b formed with and bent from the top horizontal plate 42a.

The receivers 38, 40 are supported by the cross member 42, and are spaced apart in this embodiment by approximately the distance w. Each of the receivers 38, 40 has a respective through-hole 38a, 40a. A first pin 120 extends through the through-hole 38a and is rigidly secured in place to the receiver 38. A second pin 122 similarly extends through the through-hole 40a and is rigidly secured in place to the receiver 40. In this embodiment, the through-holes 38a, 40a are formed through the horizontal plate to allow for vertical disposition of the pins 120, 122. The vertical plate 42b structurally reinforces the horizontal plate 42a.

FIG. 3 shows in further detail a perspective view of the first pin 120. The second pin 122 has an identical structure. As shown in FIG. 3, the pin 120 includes a threaded shaft portion 302, an unthreaded shaft portion 304, a hex stop 306, a lock washer 308, and a nut 310. The hex stop 306 is rigidly disposed on the unthreaded shaft portion 304 and has a width exceeding the diameter of the unthreaded shaft portion 304. The lock washer 308 is disposed on the unthreaded shaft portion 304 between the hex stop 306 and the threaded shaft portion 302. The nut 310 is rotatably coupled to threaded shaft portion 304, trapping the lock washer 308 between the hex stop 306 and the nut 310. The unthreaded shaft portion 304 also includes a bore 312 through the diameter of the unthreaded shaft portion 304. The bore 312 is configured to receive a locking pin 312a, not shown in FIG. 3 (see FIG. 2), therethrough. Referring also to FIG. 2, the first pin 120 is secured to the receiver 38 by the opposing forces of the hex stop 306 (and lockwasher 308) and the nut 310 on either side of the through-hole 38a. The unthreaded shaft portion 304 extends upwardly from the receiver 38. The second pin 122 is secured to the receiver 40 in the same way.

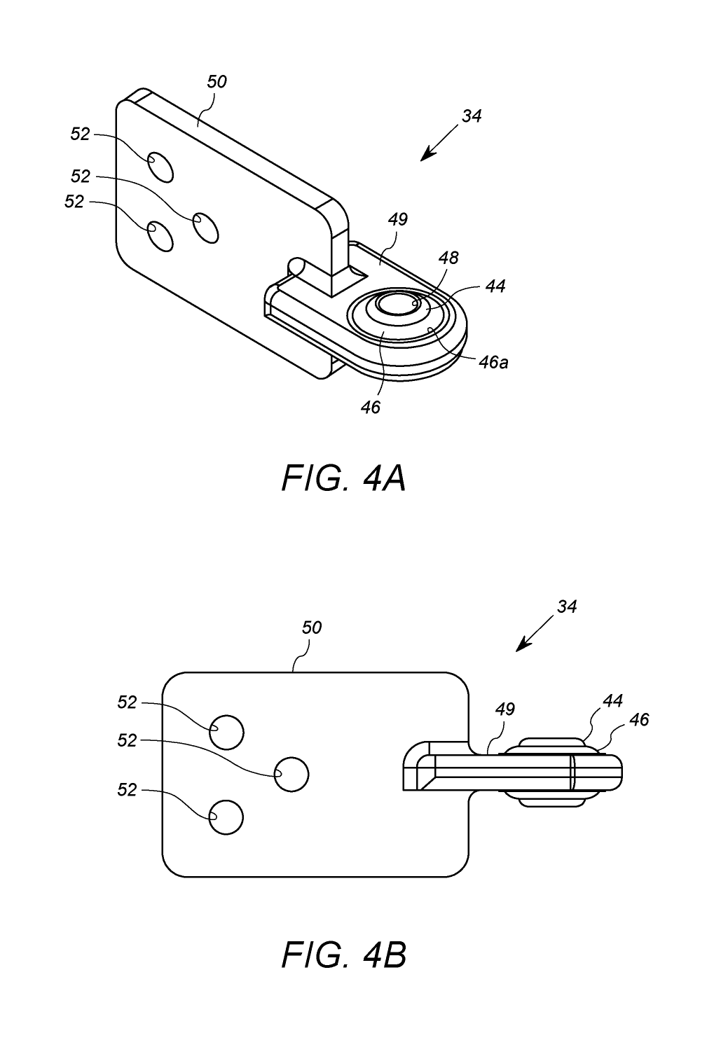

The trailer 10 further includes first and second spaced apart mounts 34, 36 rigidly coupled to the bed 12. The first mount 34 is also operably coupled to the first receiver 38, and the second mount 36 is operably coupled to the second receiver 40. FIGS. 4A and 4B show, respectively, perspective and side plan view of the first mount 34. With simultaneous reference to FIGS. 1, 4A, and 4B, the first mount 34 includes a ball and socket structure including a ball structure 44 having a bore 48 therethrough, disposed within a tight fitting socket 46. The ball structure 44 does not necessarily form a sphere, but has a convex rounded outer surface that fits within the socket 46 to permit rotational movement within the socket 46, as is known of ball and socket connections.

The socket 46 also includes a top opening 46a and a bottom opening, not shown, but having the general structure of the top opening 46a. The first mount 34 also includes a plate 50 having a plurality of bolt holes 52, and a connector arm 49 that connects the plate 50 to the socket 46. In this case, the plate 50 has three bolt holes formed in a triangular pattern. Referring again to FIGS. 1A and 1B, the second mount 36 has a structure substantially similar to the first mount 34, and thus includes a corresponding ball 54 having a bore 58, a socket 56, and a plate 60 having bolt holes, not visible in FIGS. 1A and 1B.

The first mount 34 is rigidly coupled to the first mounting plate 64 in one of a plurality of predefined height positions with respect to the bed 12. To this end, the through-holes 66 of the first mounting plate 64 are arranged to define a plurality of patterns at different heights. In this case, the through-holes 66 are arranged in an alternating pattern in two vertical columns, such that each position on either of the columns defines a height position. As can be seen in FIG. 1, the three bolt holes 52 of the first mount 34 in triangular pattern can align with pluralities of sets of triangular patterns of through-holes 66 on the first mounting plate 64. The three bolt holes 52 align with two through-holes 66 in the first column and one through-hole 66 in the second column. Three bolts, only one of which 66a is shown in FIG. 1B, secure (using corresponding nuts, not shown) the first mount 34 to the first mounting plate 64 at one of a plurality of predetermined heights.

The socket 46 and ball 44 of the first mount 34 are connected to the first receiver 38 via the first pin 120. With simultaneous reference to FIGS. 1, 2 and 3, the unthreaded shaft portion 304 of the first pin 120 extends through the bore 48 and the hole 38a of the first receiver 38. The hex stop 306 is disposed between the ball 44 and the receiver 38. A locking pin 312a extends through the bore 312 (see also FIG. 3) to secure the first pin 120 in place. It will be appreciated that although embodiment of the pin 120 shown in FIG. 3 has advantages of strength and convenience, other connectors may be used to extent through the bore 48 and bore 38a that achieve at least some of the advantages of the invention. In any event, the ball 44 may move within the socket 46 thereby allowing for some relative movement between the tongue frame 20 and the first mount 34. However, as will be discussed below, other elements substantially inhibit lateral movement of the tongue frame 20 with respect to the first mount 34, while allowing for more, but limited, vertical movement.

As discussed above, the second mount 36 has a structure substantially similar to that of the first mount 34. The second mount 36 is rigidly coupled to the second mounting plate 70 in the same height position as the first mount 34 on the first mounting plate 64. As discussed above, the second mounting plate 70 includes through-holes 72 arranged in the same manner as the through-holes 66 of the first mounting plate 64. The plate 60 of the second mount 36 includes three bolt holes, not visible in FIGS. 1A and 1B, that align with a corresponding set of through-holes 72. Three bolts, not shown but substantially identical to the bolt 66a (using corresponding nuts) secure the second mount 36 to the first mounting plate 70 at the selected one of the plurality of predetermined heights.

The socket 56 and ball 54 of the second mount 36 are connected to the second receiver 40 via a second pin 122, which extends through the bore 58 and the hole 40a of the second receiver 40. The second pin 122 has a structure substantially identical to that of the first pin 120. The ball 54 moves within the socket 56 thereby allowing for some relative movement between the tongue frame 20 and the second mount 36.

However, because of the two-point lateral connection between the tongue frame 20 and the bed 12 via the mounts 34, 36, the tongue frame 20 is substantially inhibited from lateral movement with respect to the bed 12. As such, the bed 12 is substantially inhibited from lateral movement with respect to the rear end of the vehicle (e.g. motor vehicle 202 of FIG. 2). Nevertheless, the ball-and-socket connections between the mounts 34, 36 and respective receivers 38, 40 allow for slight horizontal movement. As mentioned, above, the ball-and-socket connections between the mounts 34, 36 and respective receivers 38, 40 allow for some vertical movement, even independent vertical movement, to allow for a more predictable operation on uneven and/or bumpy roadways. By having a connection that inhibits lateral movement while allowing vertical movement, this embodiment of the invention avoids the need for a system that must be configured differently for forward and reverse travel operation. Namely, the ball-and-socket connections between the mounts 34, 36 and respective receivers 38, 40 enhance stability during forward travel without disabling the lateral rigidity between the vehicle and the trailer 10.

It will be appreciated, however, that the ball and socket connection may suitably be replaced with another type of coupling that allows vertical movement. It will also be appreciated that more or fewer than three bolts may be used to connect each of the mounts 34, 36 to the respective mounting plates 64, 70. However, the three point connection of the above described embodiment strikes a particularly useful balance among strength, stability, cost and convenience.

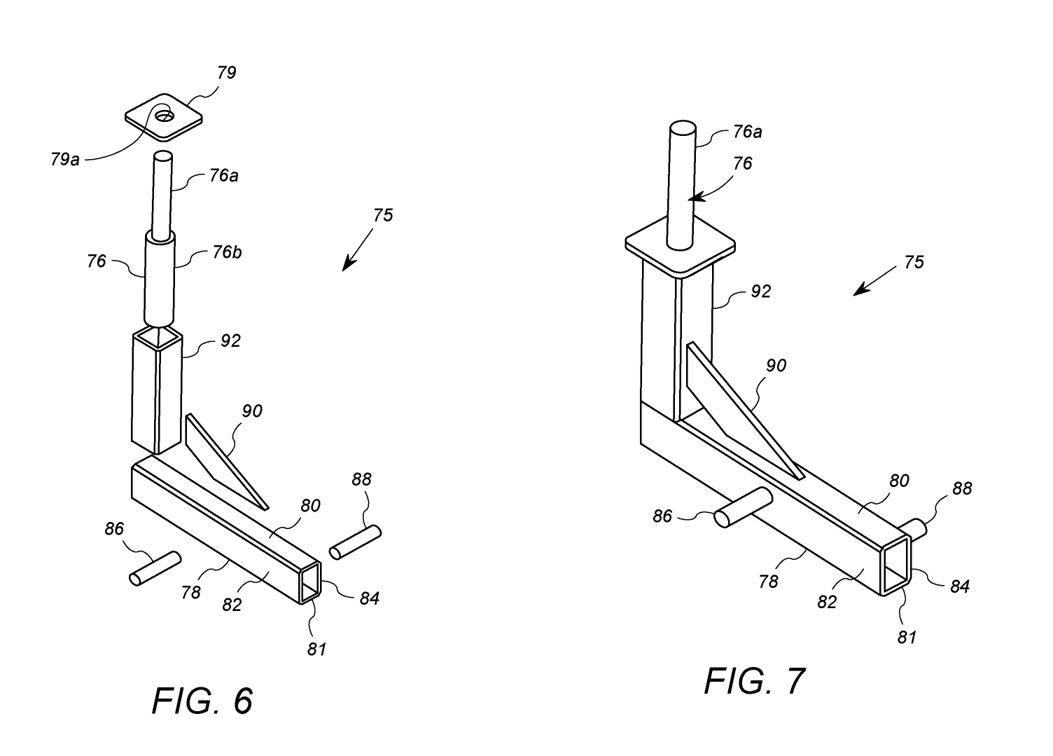

FIGS. 5, 6 and 7 illustrate further details of one embodiment of the swivel caster 22. The swivel caster 22 includes first and second wheels 26, 28 mounted on the swivel frame 75, wherein the first and second wheels 26, 28 have different axes of rotation, or in other words, are horizontally offset. FIG. 5 shows a perspective view of the swivel caster 22 and the first swivel mount plate 96 separated from the bed frame 12b, to which it is otherwise normally secured. FIG. 6 shows a perspective view of the swivel frame 75 of the first swivel caster 22 apart from the wheels 26, 28, and FIG. 7 shows an exploded perspective view of the swivel frame 75. In this embodiment, the swivel frame 75 includes a vertical spindle 76, a horizontal bar 78, a top axle plate 79, a first wheel axle 86, a second wheel axle 88, a gusset 90, a spindle housing 92.

The vertical spindle 76 is rotatably secured to the first swivel mount 96 of the bed 12 by a hub bearing assembly 77 (see FIG. 5). More specifically, the hub bearing assembly 77 has a frame 77a that is bolted to the first swivel mount plate 96, and includes a hub bearing, not shown, but would be known in the art, that is rigidly connected to the vertical spindle 76. The hub bearing of the hub bearing assembly 77, as is known in the art, rotates with respect to the frame 77a, thereby creating rotatable connection between the vertical spindle 76 to the bed 12.

The vertical spindle 76 in this embodiment is a rod having a first portion 76a with a first diameter, and a second portion 76b having a second diameter. The first portion 76a of the spindle 76 is directly coupled to the hub bearing assembly 77. The spindle housing 92 is a length of steel tube with a substantially rectangular or square cross-section, that is sized to received and reasonably tightly fit the lower portion 76b of the vertical spindle 76. The top axle plate 79 has a central opening 79a that is slightly wider than the top portion 76a, but narrower than the bottom portion 76b. The top axle plate 79 fits over the top portion 76a and abuts the bottom portion 76b. The top axle plate 79 is rigidly coupled, e.g. by welding, to the spindle 76 and the spindle housing 92, securing the bottom portion 76b within the spindle housing 92.

The spindle 76 and spindle housing 92 are generally vertically or axially oriented. The bottom of the spindle housing 92 is rigidly and directly coupled to the horizontal bar 78. The horizontal bar 78 supports and provides a connection position for the first wheel axle 86 and the second wheel axle 88. The horizontal bar 78 extends horizontally from the spindle housing 92, such that it extends substantially parallel to the ground. The horizontal bar 78 in this embodiment is a length of steel tube defining a top plate 80, a bottom plate 81, a first side 82 and a second side 84. The first wheel axle 86 is secured to the horizontal bar 78 and extends laterally outward from the first side 82. The direction of extension of the first wheel axle 86 defines the axis of rotation for the first wheel 26, and is disposed approximately midway between the spindle housing 92 and the distal end of the horizontal bar 78. The first wheel 26 is rotatably secured to the first wheel axle 86. The second wheel axle 88 is secured to the horizontal bar 78 and extends laterally outward from the second side 84, such that it extends in the opposite direction from the first wheel axle 86. The direction of extension of the second wheel axle 88 defines the axis of rotation for the second wheel 28, and is disposed approximately near the distal end of the horizontal bar 78. The second wheel 28 is rotatably secured to the second wheel axle 88. The axes of rotation of the first and second wheels 26, 28 are different, but are parallel to each other. The gusset 90 in this embodiment is a steel plate that is coupled between the top plate 80 of the horizontal bar 78 and the spindle housing 92 to reinforce the cantilevered connection therebetween.

The offset wheels 26, 28, and other features of the first swivel caster 22, help maintain stability of the swivel caster 22 when the trailer 10 is traveling at normal driving speeds at least between, for example, 30 miles per hour and 65 miles per hour. The second swivel caster has nearly identical construction, except that the positions of the wheels (and hence their respective axles, not shown) are flipped, compared to the first swivel caster 22. The second swivel caster is coupled to the bed frame 12b in the same manner, but on the opposite side of the bed 12 from the first swivel caster 22.

It will be appreciated that in one alternative embodiment, the axles 86 and 88 are not offset, or are offset to a lesser degree than shown. The swivel caster 22 and swivel frame 75 may otherwise have a substantially similar construction.

Referring again to FIGS. 1A and 1B, the trailer 10 may include any number of other structures, such as load ramps and/or a jack assembly, depending on the application.

The trailer 10 described herein provides several advantages in operation, particularly to trailers employing swivel casters. At least some of the advantages may be obtained even if offset axes of the wheels are not employed, or alternatively, if the laterally rigid but vertically flexible connection between the trailer 10 and the vehicle 202 is not employed. The easy adjustment of the tongue frame 20 provides additional advantages in trailers having swivel casters that can be useful in the absence of some of the other features described herein.

FIG. 8 shows a perspective view of a second embodiment of a trailer 110 for a motor vehicle, not shown, that includes a bed 112, a trailer tongue or coupler 118, a trailer tongue frame or coupling frame 121, and first and second swivel casters 122, 124. The swivel caster 122 includes two wheels 126, 128, and the swivel caster 124 likewise includes two wheels 130, 132. The swivel casters 122, 124 may suitably have the same structure and utilization as the swivel caster 22 and second swivel caster of the trailer 10 of FIGS. 1A and 1B. Each of the wheels 126, 128, 130, 132 has a suitably sized tire disposed on a rim in a conventional manner. The bed 112 has a front end 114 and a rear end 116. The front end 114 as discussed herein refers to the side or end that is closer to the vehicle when the trailer 110 is properly hitched, and the rear end 16 refers to opposite side or end.

The bed 112 is any structural frame and/or surface that supports a payload, or in other words, the item or items to be transported on the trailer 110, not shown. The bed 112 has a width that is generally within known trailer width standards, and comparable to that of an ordinary passenger vehicle, such as a pick-up truck. The bed 112 may have any suitable length, but in this embodiment has a length that is roughly equivalent to its width.

In this embodiment, the bed 112 is primarily formed of a steel plate 112a, with various structures attached thereto, particularly around the edges thereof. For example, the bed 112 also includes L-shaped retaining side plates 194 disposed about portions of the edge of the bed plate 112a and extending upward from the upper surface 112b of the bed plate 112a. The side plates 194 cooperate with other structures attached to the bed plate 112a, discussed further below, to retain the payload on the bed 112. The portions of the edge of the bed 112 at which the plates 194 are placed will vary based on the design of the bed 112 and other structures. The plates 194 may suitably be constructed of steel, and can be welded or bolted to the bed 112.

The bed 112 also includes first and second swivel mount plates 196, 198. The swivel mount plates 196, 198 are disposed on opposite sides near the rear end 116, and form a mounting structure for the swivel casters 122, 124. Each of the swivel mount plates 196, 198 may suitably be a small, rectangular steel plate having a central opening, not visible in FIG. 1, through which a corresponding one of the swivel casters 122, 124 is secured. The swivel mount plates 196, 198 may suitably be welded to the bed plate 112a. As discussed above, the swivel caster 22 and second swivel caster of the trailer 10 of FIGS. 1A and 1B may be coupled to the bed frame 12b substantially similar swivel mounting plates.

Also attached to the bed 12 are first and second mounting plates 164, 170. The first and second mounting plates 164, 170 are structured, positioned and implemented substantially identically to the mounting plates 64, 70 of the trailer 10 of FIGS. 1A and 1B. In this embodiment, the first and second mounting plates 164, 170 are separated by a distance w on the front end 14 that exceeds the distance d between either plate 164, 170 and its respective closest side of the bed 112. The mounting plate 164 has a plurality of through-holes 166 disposed at different heights with respect to the bed 112. The mounting plate 170 similarly comprises a plurality of through-holes 172 at different heights with respect to the bed 112. In this embodiment, each of the mounting plates 164, 170 defines opposing planar surfaces (e.g. respective surfaces 164a, 170a) and a peripheral edge 164b, 170b. The mounting plates 164, 170 are attached to the bed 112 such that each of the planar surfaces 164a, 170a extends vertically and in the front-to-rear direction.

The trailer tongue 118 is configured to be rigidly coupled to a hitch that is rigidly affixed to a motor vehicle, not shown in FIG. 1. The tongue frame 121 operably couples the trailer tongue 118 to the bed 112 proximate the front end 114 in a laterally rigid manner, such that the bed 112 is substantially inhibited from lateral movement with respect to the hitch and rear end of the vehicle.

The tongue frame 121 operably couples the trailer tongue 118 to the bed 112 proximate the front end 14 in a laterally rigid manner, such that the bed is substantially inhibited from lateral movement with respect to the hitch. Referring to FIGS. 1 and 2, the tongue frame 121 in this embodiment tongue frame 121 includes a crossbar 142 and first and second spaced apart receivers 138, 140. The trailer tongue 118 is rigidly attached to middle of the crossbar 142. In this embodiment, the trailer tongue 118 is welded to the crossbar 142, and the weld is strengthened by a gusset plate 143.

The receivers 138, 140 are supported by the crossbar 142, and are spaced apart in this embodiment by approximately the distance w. Each of the receivers 138, 140 has a respective through-hole. A first pin 220 extends through one of the through-holes and is rigidly secured in place to the receiver 138. A second pin 222 similarly extends through the other through-hole and is rigidly secured in place to the receiver 140. The pins 220, 222 may suitably have the same structure as the pin 120 of FIG. 3.

The trailer 110 further includes first and second spaced apart mounts 134, 136 rigidly coupled to the bed 112. The first mount 134 is also operably coupled to the first receiver 138, and the second mount 136 is operably coupled to the second receiver 140. The mounts 134, 136 may suitably have the same structure and implementation as the mounts 34 of FIGS. 4A and 4B. The mounts 134, 136 furthermore couple to the respective mounting plates 164, 170 in substantially the same manner as the mounts 34, 36 couple to the mounting plates 64, 70 of FIGS. 1A and 1B.

For example, the first mount 134 is rigidly coupled to the first mounting plate 164 in one of a plurality of predefined height positions with respect to the bed 112. As can be seen in FIG. 8, three bolt holes of the first mount 134 in triangular pattern can align with pluralities of sets of triangular patterns of through-holes 166 on the first mounting plate 164. Three bolts secure the first mount 134 to the first mounting plate 164 at one of a plurality of predetermined heights.

The trailer 110 may include any number of other structures, depending on the application. The example of FIG. 8 includes retractable work vehicle load ramps 230, and a front jack assembly 232. The work vehicle load ramps 230 in this embodiment are attached to the side of the bed 112, and can be extended to form ramps that lead from the ground to the bed 112. In the extended state, not shown, work equipment such as small tractors, lawn mowers, etc., may be wheeled onto the bed. The load ramps 230 may then be retracted as shown in FIG. 1 for transport. The front jack assembly 232 is a standard piece of equipment on any two-wheel trailer and is operably coupled to the front of the bed 112.

More specifically, it will be appreciated that the above described embodiments are merely illustrative, and that those of ordinary skill in the art may readily devise their own implementations and modifications that incorporate the principles of the present invention and fall within the spirit and scope thereof.

What is claimed is:

1. A trailer for a motor vehicle, comprising:
a bed having a front end and a rear end, the bed configured to receive a load to be transported by the trailer;
a trailer tongue configured to be rigidly coupled to a hitch, the hitch rigidly affixed to a motor vehicle;
a tongue frame operably coupling the trailer tongue to the bed proximate the front end in a laterally rigid manner, such that the bed is substantially inhibited from lateral movement with respect to the hitch; and
a plurality of swivel frames operably rotatably coupled to the bed, each of the plurality of swivel frames including at least one wheel rotatably attached thereto.

2. The trailer of claim 1, further comprising first and second spaced apart mounts rigidly coupled to the bed, and wherein the tongue frame further comprises first and second spaced apart receivers, each receiver coupled to a corresponding one of the first and second spaced apart mounts.

3. The trailer of claim 2, wherein each receiver is moveably coupled to the corresponding mount to enable vertical relative movement therebetween.

4. The trailer of claim 3, wherein the first mount includes a ball disposed in a socket that connects to the first receiver.

5. The trailer of claim 4, further comprising a pin rigidly affixed to the receiver and extending through a bore in the ball.

6. The trailer of claim 5, wherein each of the plurality of swivel frames includes two wheels rotatably attached thereto, and wherein each of the two wheels has a different axis of rotation.

7. The trailer of claim 1, wherein each of the plurality of swivel frames includes two wheels rotatably attached thereto.

8. The trailer of claim 1, wherein the trailer tongue is configured to be received by a sleeve of the trailer hitch.

9. The trailer of claim 1, wherein the bed includes a top surface configured to support the load to be transported by the trailer.

10. A trailer for a motor vehicle, comprising:
a bed having a front end and a rear end, the bed configured to receive a load to be transported by the trailer;
a coupler configured to be coupled to a hitch, the hitch affixed to a motor vehicle;
a coupling frame operably connecting the coupler to the bed proximate the front end; and
a plurality of swivel frames operably rotatably coupled to the bed, each of the plurality of swivel frames including two wheels rotatably attached thereto, and wherein each of the two wheels has a different axis of rotation.

11. The trailer of claim 10, wherein each of the plurality of swivel frames includes:
a vertical spindle operably rotatably affixed to the bed;
a horizontal bar coupled to the vertical spindle, a first axle and a second axle affixed to and extending in opposite directions from the horizontal bar, and
wherein each of the two wheels is rotatably affixed to a corresponding one of the first and second axles.

12. The trailer of claim 11, wherein the horizontal bar has a top, a first side and a second side, wherein the first axle is directly and rigidly connected to the first side, and the second axle is directly and rigidly connected to the second side.

13. The trailer of claim 11, wherein:
the coupler is configured to be rigidly coupled to the hitch; and
the coupling frame operably couples the coupler to the bed proximate the front end in a laterally rigid manner, such that the bed is substantially non-articulating with respect to the hitch.

14. A trailer for a motor vehicle, comprising:
a bed having a front end and a rear end, the bed configured to receive a load to be transported by the trailer;
a coupler configured to be coupled to a hitch, the hitch rigidly affixed to a motor vehicle;
a coupler frame operably coupling the coupler tongue to the bed proximate the front end in a laterally rigid manner, such that the bed is substantially inhibited from lateral movement with respect to the receiver;
first and second spaced apart mounts rigidly coupled to the bed in one of a plurality, and wherein the coupler frame further comprises first and second spaced apart receivers, each receiver coupled to a corresponding one of the first and second spaced apart mounts; and
a plurality of swivel frames operably rotatably coupled to the bed, each of the plurality of swivel frames including at least one wheel rotatably attached thereto.

15. The trailer of claim 14, wherein the first and second spaced apart mounts are rigidly coupled in one of a plurality of predefined height positions with respect to the bed.

16. The trailer of claim 15, further comprising first and second mounting plates affixed to the bed, each of the mounting plates having a plurality of mounting holes at different heights with respect to the bed; and
wherein the first mount is bolted to at least one of the plurality of mounting holes of the first mounting plate, and is not bolted to at least one other of the plurality of mounting holes of the first mounting plate, and the second mount is bolted to at least one of the plurality of mounting holes of the second mounting plate, and is not bolted to at least one other of the plurality of mounting holes of the second mounting plate;

17. The trailer of claim 15, wherein the first mount includes a ball disposed in a socket that connects to the first receiver.
